(19) United States
(12) Patent Application Publication
(10) Pub. No.: US 2023/0173995 A1
(43) Pub. Date: Jun. 8, 2023

(54) SUCTION MOUNT FOR VEHICLE CAMERA

(71) Applicant: INNOVATIVE AFTERMARKET GROUP, CHANDLER, AZ (US)

(72) Inventors: Carl Anthony Avila, Phoenix, AZ (US); Satya Vamshi Pattela, Tempe, AZ (US)

(21) Appl. No.: 17/932,224

(22) Filed: Sep. 14, 2022

Related U.S. Application Data
(60) Provisional application No. 63/261,250, filed on Sep. 15, 2021.

(51) Int. Cl. B60R 11/04

(52) U.S. Cl. CPC B60R 11/04; B60R 2011/0026

(57) ABSTRACT

An improved mounting system for mounting an onboard camera in a vehicle includes a suction cup that can visibly display information to persons outside of the vehicle in response to inputs from a vehicle security system or from an owner or other authorized user. The mounting system can be mounted to the interior surface a vehicle windshield or other window with the suction cup, which can project such information to persons outside of the vehicle.

### RELATED APPLICATION

This patent application claims the benefit of U.S. Provisional Application No. 63/261,250, filed Sep. 15, 2021 entitled “SUCTION MOUNT FOR VEHICLE CAMERA,” which is incorporated in this application in its entirety by this reference as if fully set forth herein.

### BACKGROUND

This invention relates to mounts for attaching an onboard camera to the windshield or other window of a vehicle. More particularly, it relates to such a mount that has a suction cup for mounting the camera to a vehicle windshield or window and that can also project a lighted logo or other image or message onto the vehicle windshield or window, and that can be controlled by a vehicle security system.

Security systems for automobiles are in common use today to protect against unauthorized entry into the vehicle by sounding an alarm in the event of a detected intrusion event. Such systems include trigger and sensor devices for monitoring the status of doors and other entry points such as the hood and trunk. Some vehicle security systems also include an onboard camera mounted inside the vehicle.

It is an object of the present invention to provide an improved mounting system that can be used to mount an onboard camera of a vehicle and can also visibly project information to persons outside of the vehicle in response to inputs from a user or a vehicle security system.

It is yet another object of the present invention to provide such a camera mounting system that can be mounted to the interior surface of a vehicle windshield or other window via a mount suction cup that can project information to persons outside of the vehicle.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a suction mount for mounting an onboard camera to a window of a vehicle. The suction mount includes a support structure configured to hold a camera and a suction cup configured for mounting to a window of a vehicle. The suction cup has a mounting surface that faces the window when the suction cup is mounted to the window. The suction cup includes one or more light sources positioned to project light toward the vehicle window when the suction cup is mounted to the window of the vehicle. The suction cup also includes a translucent area and may include an opaque area configured in a pattern so that when the one or more light sources is energized, the projected light forms a pattern (such as a logo) viewable by a person outside the vehicle.

According to one advantageous aspect of the invention, the light sources can be controlled via a vehicle security system that can selectively energize the light sources based on a vehicle or server event state, such as when the vehicle ignition is off, when the vehicle ignition is on, when the security system is armed, and when the vehicle exits a geofence.

According to another aspect of the invention, a user can send custom or predetermined messaging via a server to be displayed by the suction cup.

### BRIEF DESCRIPTION OF THE DRAWINGS

The accompanying drawings, which are incorporated in and constitute a part of the specification, illustrate the presently preferred embodiments of the invention, and together with the general description given above and the detailed description of the preferred methods and embodiments given below, serve to explain the principles of the invention.

FIG. 1 is a perspective view of a previously known camera suction mount showing the support structure and camera mounted to the windshield of a vehicle.

FIG. 2A is a side view of one embodiment of a novel suction cup according to the present invention.

FIG. 2B is a cross-sectional view of one embodiment of the suction cup of FIG. 2A taken through plane B-B of FIG. 2A.

FIG. 2C is a cross-sectional view of another embodiment of the suction cup of FIG. 2A, taken through plane B-B of FIG. 2A and showing a different distribution of LED light sources.

FIG. 3 is a block diagram showing power and input/output connections between a suction mount of the present invention and a vehicle onboard camera.

FIG. 4 is a block diagram illustrating the signal flow for one embodiment of a suction mount according to the present invention, showing how the suction mount communicates with the onboard camera, the vehicle security system, and a server.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

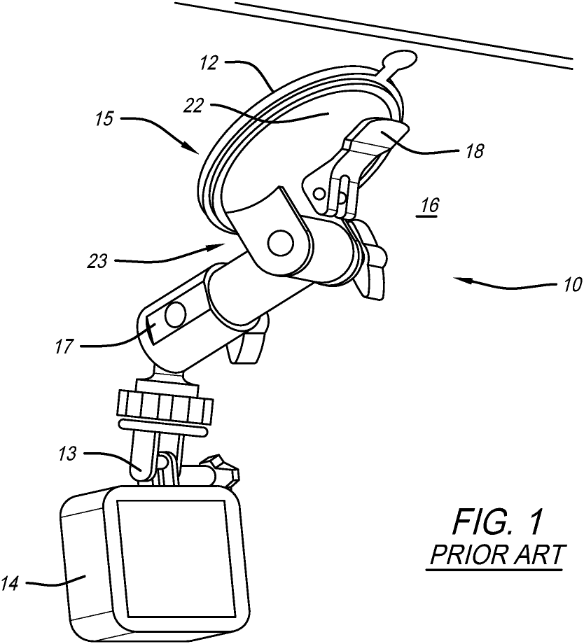

Referring to FIG. 1, a known embodiment of a suction mount 10 includes a suction cup 12 disposed at the base of a camera support structure 13 such as a support arm 17. The suction cup 12 includes a frame 22 for holding a flexible mounting surface 15 that faces the window 16 when the suction cup 12 is mounted to the window. The frame 22 includes a mounting structure 23 for mounting the camera support structure 13 to the suction cup frame 22. The suction mount 10 can be used for mounting an on-board camera 14 to the interior surface of a windshield or other window 16 of a vehicle to capture images inside the vehicle. In a presently preferred embodiment, the suction cup 12 can include a suction lever mechanism 18, as is known in the art, for helping lower pressure inside the suction cup 12 so that the suction cup 12 will stick to a flat surface.

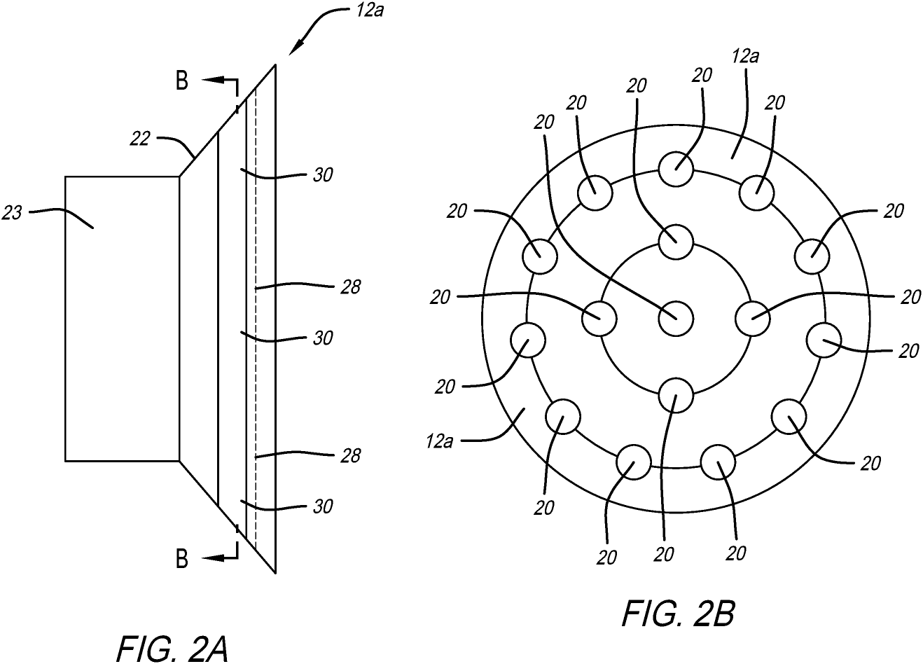

According to the present invention, an improved suction mount 10a is provided, which includes a novel suction cup 12a that is configured to project an image (such as an image of a logo) or other information onto the vehicle windshield 16 or other window. Referring to FIGS. 2A and 2B, in one embodiment, the suction cup 12a includes light sources comprising a plurality of individual LEDs 20 disposed in the suction cup frame 22. In this configuration, the LEDs 20 are positioned to project light toward the vehicle window 16 when the suction cup 12a is mounted to it. The LEDs 20 can be energized via a switch 26 in the suction mount 10a. The suction cup 12a includes a translucent area 28, and in some embodiments can include an opaque area 30 that is disposed in a pattern so that when one or more of the LEDs 20 is energized, the projected light forms a pattern viewable by a person outside the vehicle. For example the opaque area 30 can be a printed opaque layer disposed in the translucent/transparent area 28 of the suction cup 12a. In this configuration, the light from the LEDs 20 will only pass through the translucent/transparent area 28 of the suction cup 12a and not the opaque area 30, thereby projecting the pattern as an image (such as a logo or trademark) onto the vehicle windshield 16.

In some embodiments, the suction cup 12a can include a matrix of LEDs 20 that can be controlled by a controller that can be programmed or instructed to light the LEDs to display logos, words phrases or sentences (which can be scrolling text). These lighted displays can be automatically selected depending on the state of the GPS tracker 34 or other vehicle security device sensors. For example, when the GPS tracker 34 and/or another security device sensor is in an armed state, the LEDs 20 could display the message “ARMED.” In the case of an ARM “breach” (e.g., a stolen car or glass break) the LEDs 20 could display an array of various messages like, “Help”, “Call 911” “I am stolen” or flash various color lights.

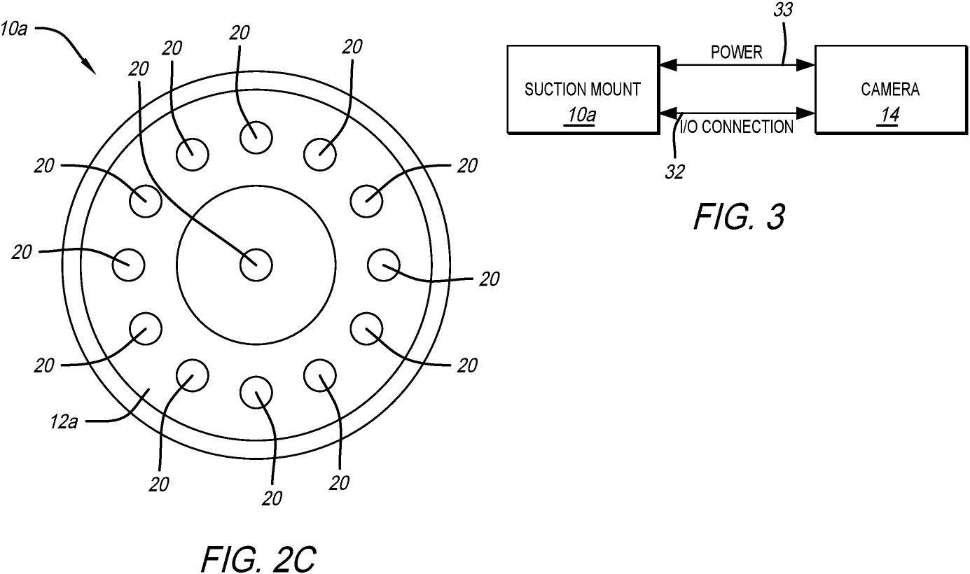

Referring to FIG. 3, the suction mount 10a can draw power from the on-board camera 14 via a power connection 33 and can be controlled via an I/O connection 32 with the camera 14. With the I/O connection 32, the LEDs 20 can be controlled to display different colors and/or different pulsed light sequences for different triggering events (e.g., as described below) so that a person viewing the LED display can identify which triggering event is occurring.

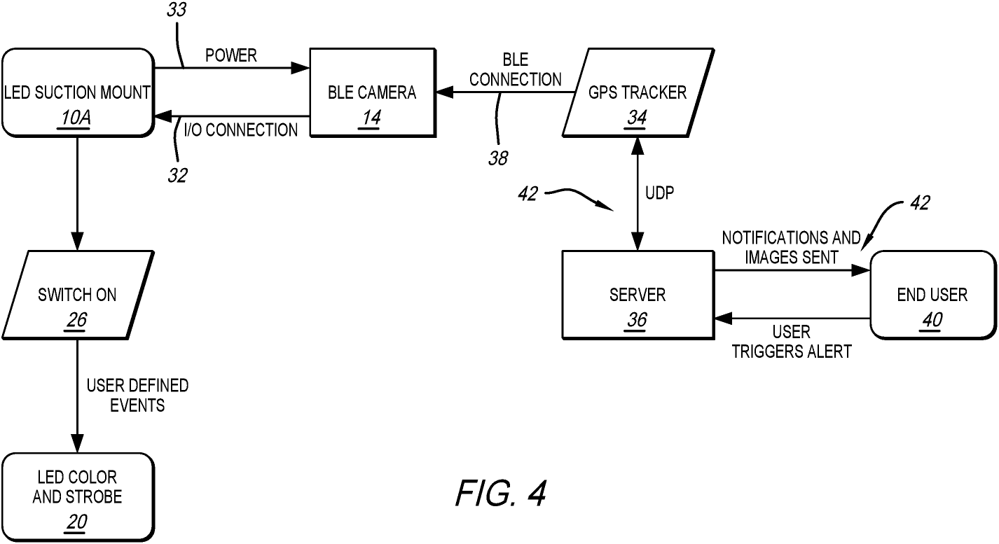

As shown in FIG. 4, the onboard camera 14 can be in communication (such as via a Bluetooth wireless connection 38) with a GPS tracker 34 in the vehicle, and the LED display can be controlled by commands from a user 40 sent via a server 36 to the GPS tracker 34. In one presently preferred embodiment, the GPS tracker 34 is a modular unit equipped with a processor, a GPS tracking component, a Bluetooth wireless (BLE) device, and a cellular modem. The GPS tracker 34 can receive power from the vehicle OBD connector, as described in U.S. Pat. No. US 10,597,000 B2, entitled “Glass Break Sensor System,” which by this reference is incorporated into this specification as if fully set forth herein. The processor and BLE device can be part of a system-on-a-chip (SoC). The GPS tracker 34 can communicate with the onboard camera 14 via the BLE device. The server 36 can access and communicate with the GPS tracker 34 via the Internet 42. For example, in the embodiment shown in FIG. 4, the cellular modem can be an LTE 4G modem that communicates with the server 36 over an LTE 4G mobile network using User Datagram Protocol (UDP). In this configuration, a user 40 can communicate with the server 36 using, a mobile device (not shown) via Wi-Fi or the 4G mobile network (whichever network the user 40 is using), and the server 36 can in turn communicate with the GPS tracker 34 over the LTE 4G network.

Still referring to FIG. 4, the LEDs 20 of the suction cup 12a can be controlled via a vehicle security system configured to cause the LEDs 20 to display certain information based on triggering events sensed by the security system or based on vehicle or server event states, such as Ignition Off, Ignition On, Arm, or Geofence Exit. One such vehicle security system utilizing a GPS tracker and an onboard camera that captures an image in response to an alarm sensor is described in U.S. Pat. No. 10,597,000 to Avila, entitled “Glass Break Sensor System,” which is incorporated by this reference as if fully set forth herein. This feature can help in identifying when the vehicle security system is armed or disarmed, when the camera battery is low, or other system status alerts. Also, the LEDs 20 can be controlled to display messages (e.g., an SOS alert) initiated by the vehicle owner or other authorized user 40. Such messages can be customized by the user or can be predefined messages to be displayed in response to trigger commands selected by the user, such as when the user sends a trigger command to display a “stolen vehicle” alert or an SOS alert.

Still referring to FIG. 4, one exemplary vehicle security system can include the GPS tracker 34, onboard camera 14, and/or other security system components (not shown) (e.g., a glass-break sensor). When the vehicle security system is in an “Armed” state, the GPS tracker 34 can cause the LEDs 20 of the suction cup 12a to display the status of the system as “Armed” or “Live Monitoring” in a scrolling fashion. The vehicle owner or other user 40 can also have the option to send custom or predetermined messaging to be display on the suction cup 12a, such as “Call 911” or flashing LEDs to alert nearby authorities. Such messages can be communicated by the user’s mobile device (such as via a mobile app on the user’s mobile device) to the server 36 or can be selected from predefined messages stored at or in a manner so that they are accessible to the server 36. The messages can then be sent by the server 36 to the GPS tracker 34, BLE camera 14, and suction mount 10a for display, as described above.

The user 40 can interactively select which message to display via a mobile device (e.g., with a mobile app) or by via the server 36 (which can comprise an interactive portal), with their desk top computer. For example, the vehicle owner or other authorized user 40 can open a mobile app on their mobile device (or access the interactive portal via their mobile device or desktop computer), select the message the user 40 wants to display when system is in the “Armed” state, and also select the message to be displayed if an “Armed Breach” is detected by the vehicle security system. After the user 40 makes this selection, it can be stored at the server 36. That message can then be sent via the LTE 4G network to the GPS tracker 34 and can be communicated to the suction mount 10a via the BLE camera 14 for display by the LEDs 20 of the suction cup 12a when the security system is in the “Armed” state. In the event of an armed breach (i.e., detection of an intrusion or other triggering event after the system is armed), the GPS tracker 34 can (i) cause the BLE camera 14 to begin capturing images and (ii) send a notification of the triggering event and the captured images to the server 36, which can send the notification and images to the end user 40).

From the foregoing, it can be seen that the present invention provides an improved mounting system that can be used to mount an onboard camera in a vehicle and can also visibly display information to persons outside of the vehicle in response to inputs from a user or a vehicle security system. The mounting system can be mounted to the interior surface of a vehicle windshield or other window with a suction cup that can project such information to persons outside of the vehicle.

Upon reading this disclosure, additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

What is claimed is:

1. A suction mount for mounting a camera to a window of a vehicle, the suction mount comprising:
a support structure configured to hold a camera; and
a suction cup configured for mounting to a window of a vehicle and having a bottom surface that faces the window when the suction cup is mounted to the window;
wherein the suction cup includes one or more light sources positioned to project light through a flexible translucent member and toward the vehicle window when the suction cup is mounted to the window of the vehicle.

2. The suction mount of claim 1 wherein the suction cup includes an opaque area that is disposed in a pattern so that when the one or more light sources are energized, the projected light forms a pattern viewable by a person outside the vehicle.

3. The suction mount of claim 1 further comprising a power input coupled to the camera and the one or more light sources.

4. The suction mount of claim 1 wherein the suction cup includes control inputs from the camera.

5. The suction mount of claim 1 wherein the pattern viewable by a person outside the vehicle comprises an image of a logo or trademark.

6. The suction mount of claim 1 wherein the camera is coupled to a server configured to send message information to the suction cup control inputs.
